(19) United States
(12) Patent Application Publication
(10) Pub. No.: US 2004/0062619 A1
(43) Pub. Date: Apr. 1, 2004

(54) Multiple-stage drilling tool

(75) Inventor: Josef Ruppert, Holzgerlingen (DE)

Correspondence Address: Woodling, Krost and Rust, Kenneth L. Mitchell, 9213 Chillicothe Road, Kirtland, OH, 44094, US

(73) Assignee: RUKO GmbH Prazisionswerkzeuge

(21) Appl. No.: 10/622,436

(22) Filed: Jul. 18, 2003

(30) Foreign Application Priority Data
Aug. 16, 2002 (DE) 202 12 852.0

(51) Int. Cl. B23B 51/04

(52) U.S. Cl. 408/204

(57) ABSTRACT

Multiple-stage drilling tool with chip groove for drilling different bit diameters as required, which increase from stage to stage, is disclosed. The invention is characterized by a first bit stage (1-1) designed as core bit, and at least one second bit stage (1-2, 1-3) arranged above it in the form of a step, where a hole can be drilled by the core bit leaving an uncut cylinder-shaped drilling core.

The invention relates to a multiple-stage drilling tool with chip groove for drilling different hole diameters as required.

The advantage of such multiple-stage drilling tools is that holes of different diameters can be drilled without changing the drilling tool.

Multiple-stage drilling tools can be used both in hand-held or in stationary drilling equipment.

A multiple-stage bit has various stages, 1, 2, 3 etc. for different imaginary hole diameters D1, D2, D3 etc. (D1<D2<D3).

To drill a hole of diameter D3, a hole of diameter D1 is first drilled with the first stage. This is then widened to diameter D2 with the second stage and finally to diameter D3 with the third stage.

The German utility model reg. no. G 94 14 659.4 describes a multiple-stage bit with separate stages whose diameter increases in steps from the tip of the bit in the direction of the rotation axis and which has a spiral chip groove. In this multiple-stage bit as known to prior art, the first stage functions in the manner of a conventional spiral bit, i.e. when drilling the first hole with diameter D1, all the material removed is cut into chips.

This results in the following drawbacks:

The cut material removed from the bore cannot be re-used directly.

The bit at the first stage is exposed to increased wear and stress.

The drilling process is more time-consuming.

The tool always requires a guide bore.

When the tool is worn, it cannot be re-ground to its original geometry.

With a tool of this kind, no segment-shaped holes can be drilled at the edge of material, since the guide bit would run outside the material.

To eliminate these disadvantages, the invention aims to provide a multiple-stage drilling tool where the material being drilled is not completely cut by the first bit stage, and which reduces the wear and tear on the first bit stage.

The purpose of the invention is fulfilled by the characterising features of claim 1: The most important feature of the multiple-stage drilling tool in accordance with the invention is that the first bit stage is designed as a core bit.

This produces the following advantages: through the design of the tool, the geometry of the teeth can be optimised, which improves the cutting capacity, i.e. the drilling process is speeded up, in particular with thick materials and greater diameters. Through the reduced cutting area on the workpiece, less heat is induced into the material being cut.

In addition, it is possible to re-grind the tool to its original geometry.

A core bit in accordance with this document is a bit in form of a hollow cylinder rotating around its own axis whose front cutting surface creates a bore while leaving a core (of a lower diameter than the bore itself). In a drilling process of this kind, the core is not cut into chips and can be re-used.

The diameter D1 of the bore is determined by the outer dimension of the outer cutter Ca1, while the diameter of the cylinder-shaped (uncut) core is determined by the inner dimension of the inner cutters Ci1.

Further advantageous developments of the multiple-stage drilling tool in accordance with the invention are described in the sub-claims.

In the following, the multiple-stage drilling tool in accordance with the invention is designated as the multiple-stage core bit.

A practical example of the multiple-stage drilling tool in accordance with the invention is shown in the drawings and is described in more detail below.

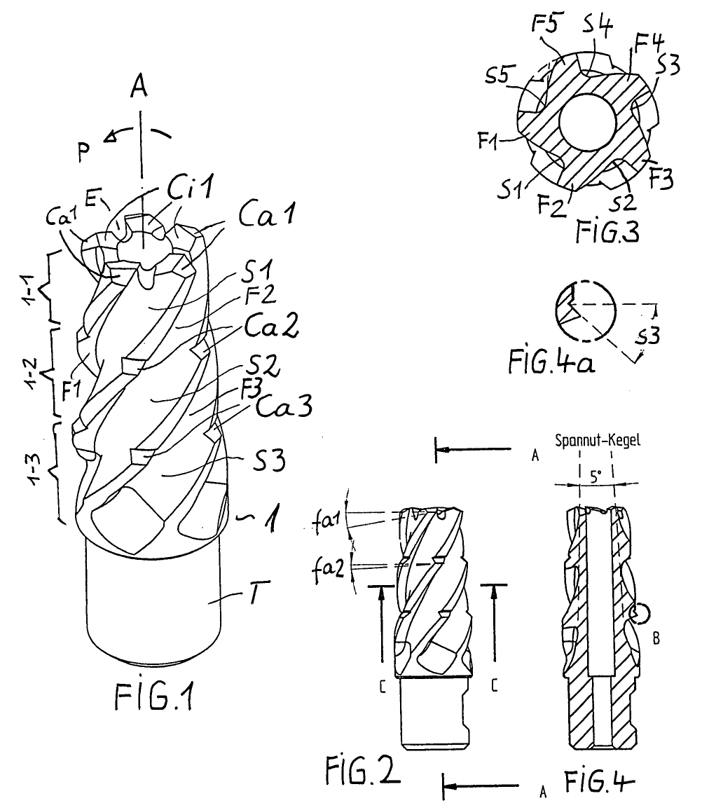

FIG. 1

A perspective view of the multiple-stage core bit in accordance with the invention with three bit stages.

FIG. 2

A side view of the multiple-stage core bit in accordance with the invention with the outer-cutter clearance angle fa1 of the first bit stage and the outer-cutter clearance angle fa2 of the second bit stage marked.

FIG. 3

A sectional view of the multiple-stage core bit in accordance with the invention as shown in section CC of FIG. 2 to illustrate the shape of the chip groove.

FIG. 4

A sectional view of the multiple-stage core bit in accordance with the invention as shown in section AA of FIG. 3 to illustrate the cutting angle s3 of an outer cutter for the third bit stage as well as an imaginary chip-groove cone.

FIG. 4a

The enlarged individual view B as shown in FIG. 4 to illustrate the cutting angle s3.

FIG. 1 shows

A perspective view of the multiple-stage core bit 1 in accordance with the invention with the first 1-1, second 1-2 and third bit stage 1-2 marked.

The chip grooves are marked S1, S2, S3, S4, S5 (due to the view selected, FIG. 1 shows only grooves S1, S2 and S3; FIG. 3 shows all the chip grooves S1 to S5). The heels adjacent to the chip grooves are marked F1, F2, F3, F4, F5 (due to the view selected, FIG. 1 shows only the heels F1 to F3; FIG. 3 shows all the heels F1 to F5).

The first bit stage 1-1 produces a bore with an imaginary diameter D1, the second bit stage 1-2 enlarges the bore D1 to diameter D2, and the third bit stage 1-3 enlarges the bore D2 to diameter D3.

The maximum depth of the bore in each case depends on the height of the bit stages.

All the bit stages have a common axis of rotation A. The multiple-stage core bit rotates in direction P.

The bit stages 1-1, 1-2, 1-3 are arranged in steps above one another (starting from the first bit stage). The outer diameters of the bit increase from stage to stage.

The first bit stage 1-1 is in the form of a core bit. In the area close to the bore, U-shaped notches E are provided between the heels.

Each of these notches E runs into an inner cutter Ci whose clearance angle (not shown) is preferably 5 to 10 degrees (when the multiple-stage tool is used for different materials).

In the heels (F1 to F5) adjoining the chip grooves (F1 to F5) outer cutters Ca1 are provided in the area close to the bore.

The cutter clearance angle fa1 of these outer cutters Ca1 is preferably between 6 and 15 degrees (see FIG. 2). This range allows universal use of the multiple-stage core bit for different materials.

The outer cutters of the second bit stage 1-2 are marked Ca2, and those of the third stage 1-3 are marked Ca3. The paths of the chip grooves S1 to S5 of the multiple-stage core bit are preferably spiral in shape. However, their path may be straight or of another shape.

In a preferred version of the multiple-stage core bit in accordance with the invention, all the bit stages have at least one common chip groove.

The chip groove may have a flat or arched base, flanks of unequal height, flanks which are either vertical or diagonal to the groove base, or flanks which are arched (rounded).

The optimum form of the chip groove is the form which assures the most efficient chip removal and depends on the material being drilled, the geometry of the multiple-stage core bit and the drilling process itself (forward feed and rotation speed).

Preferably, the path of the chip groove of the multiple-stage core bit, whose successive bit stages increase in diameter, should correspond to an imaginary cone with virtually constant groove depth.

In certain applications, a more efficient chip removal is achieved if the chip groove of each bit stage is formed as a spiral-groove segment which is smaller in size than a quarter of a full spiral turn.

In simple cases, the core bit of the first stage may have continuous cutters from the inside to the outside.

For a divided cutting process, it is advantageous for the core bit of the first stage to have cutters inside Ci1 and outside Ca1 (see FIG. 1).

The outer cutters Ca1 in the area near the bore are located in the heels adjacent to the chip groove.

In the area near the bore, the core bit has U-shaped notches E between two heels, and an inner cutter Ci1 is assigned to each notch.

For further division of chips, the core bit of the first stage may have, in addition to the inner and outer cutter, at least one further cutter which is located in the area of the above-mentioned inner and outer cutters.

FIG. 2 shows

A side view of the multiple-stage core bit 1 in accordance with the invention with the clearance angle fa1 of the outer cutter Ca1 of the first bit stage 1-1 and the clearance angle fa2 of the outer cutter Ca2 of the second bit stage 1-2 marked. (The cutter clearance angle is formed between the grinding plane behind the cutting edge and an imaginary horizontal plane).

The cutter clearance angle fa1 of the outer cutter Ca1 of the core bit is preferably between 6 and 15 degrees. This range permits optimum adaptation to the material characteristics of the workpiece.

This angle fa1 has an effect on the chip formation of the tool. It avoids a blunt pressure of the tooth back on the material and creates a desirable degree of grip in use.

From the second bit stage, each stage 1-2, 1-3 has at least one outer cutter whose clearance angle is less than or equal to 10 degrees.

This clearance-angle range has the following advantages: the cutter back can run freely without touching the material over a wide area. In addition, the cutter is sufficiently stabilised by the lower number of degrees of the angle fa2 (compared to fa1).

From the second bit stage, the clearance angle of all the outer cutters is preferably the same.

From the second stage, the outer cutter assumes an angle of between 0 and 45 degrees to an imaginary horizontal plane. This angle range has the following advantages: through the selection of an angle range from 0 to 45 degrees, it is possible gradually to increase the cutting area to the next largest diameter. This permits a constant increase in cutting power, thereby avoiding stress peaks for the tool.

The multiple-stage core bit in accordance with the invention is connected to the drilling machine by its shaft T (FIG. 1), e.g. through a clamping chuck or a releasable form-fitting bit seat.

1. Multiple-stage drilling tool with chip groove for drilling different bit diameters as required, which increase from stage to stage, characterised by a first bit stage (1-1) designed as core bit, and at least one second bit stage (1-2, 1-3) arranged above it in the form of a step, where a hole can be drilled by the core bit leaving an uncut cylinder-shaped drilling core.

2. Arrangement in accordance with claim 1, characterised in that all the bit stages (1-1, 1-2, 1-3) have at least one common chip groove (S1, S2, S3, S4, S5).

3. Arrangement in accordance with claim 2, characterised in that the chip groove has an even or an arched base.

4. Arrangement in accordance with claim 2, characterised in that the chip groove has flanks of unequal height.

5. Arrangement in accordance with claim 3, characterised in that the chip groove has flanks of unequal height.

6. Arrangement in accordance with claim 2, characterised in that at least one flank of the chip groove is vertical or diagonal to the groove base.

7. Arrangement in accordance with claim 3, characterised in that at least one flank of the chip groove is vertical or diagonal to the groove base.

8. Arrangement in accordance with claim 4, characterised in that at least one flank of the chip groove is vertical or diagonal to the groove base.

9. Arrangement in accordance with claim 2, characterised in that at least one groove flank is rounded.

10. Arrangement in accordance with claim 3, characterised in that at least one groove flank is rounded.

11. Arrangement in accordance with claim 4, characterised in that at least one groove flank is rounded.

12. Arrangement in accordance with claim 1, characterised in that the path of the chip groove on the multiple-stage drilling tool, with the increasing diameter of successive bit stages, runs in an imaginary cone with virtually the same groove depth.

13. Arrangement in accordance with claim 2, characterised in that the path of the chip groove on the multiple-stage drilling tool, with the increasing diameter of successive bit stages, runs in an imaginary cone with virtually the same groove depth.

14. Arrangement in accordance with claim 3, characterised in that the path of the chip groove on the multiple-stage drilling tool, with the increasing diameter of successive bit stages, runs in an imaginary cone with virtually the same groove depth.

15. Arrangement in accordance with claim 2, characterised in that the course of the chip groove is spiral-shaped or straight.

16. Arrangement in accordance with claim 3, characterised in that the course of the chip groove is spiral-shaped or straight.

17. Arrangement in accordance with claim 15, characterised in that the chip groove of each bit stage is a spiral-groove segment smaller than a quarter of a full spiral turn.

18. Arrangement in accordance with claim 16, characterised in that the chip groove of each bit stage is a spiral-groove segment smaller than a quarter of a full spiral turn.

19. Arrangement in accordance with claim 1, characterised in that the core bit of the first bit stage has cutters running continuously from the inside to the outside.

20. Arrangement in accordance with claim 1, characterised in that the core bit of the first bit stage (1-1) has inner cutters (Ci1) and outer cutters (Ca1), where the outer cutters (Ca1) are located in the area close to the bore of the heels (F1 to F5) which are adjacent to the chip groove (S1 to S5), and the core bit has U-shaped notches (E) in the area close to the bore between two heels (F1 to F5), and an inner cutter (Ci1) is assigned to each notch (E).

21. Arrangement in accordance with claim 20, characterised in that the core bit of the first bit stage has at least one other cutter in addition to the inner and outer cutter, which is arranged in the area of the above-mentioned inner and outer cutters.

22. Arrangement in accordance with claim 20, characterised in that the clearance angle (fa1) of the outer cutter of the core bit measures between 6 and 15 degrees.

23. Arrangement in accordance with claim 1, characterised in that from the second bit stage (1-2, 1-3) onwards, each bit stage has at least one outer cutter (Ca2, Ca3), whose clearance angle (fa2) is less than or equal to 10 degrees.

24. Arrangement in accordance with claim 23, characterised in that the clearance angle (fa2) of all the outer cutters (Ca2) from the second bit stage (1-2) onwards are equal.

25. Arrangement in accordance with claim 23, characterised in that the outer cutter (Ca2) from the second bit stage (1-2) is at an angle s3 of between 0 and 45 degrees to an imaginary horizontal plane.

26. Arrangement in accordance with claim 20, characterised in that, on the core bit, the clearance angle of the inner cutter is between 5 and 10 degrees.
